(19) United States
(12) Patent Application Publication
(10) Pub. No.: US 2025/0373701 A1
(43) Pub. Date: Dec. 4, 2025

(54) SUPPORT API PREFIX IN CALLBACK URI

(71) Applicant: Nokia Technologies Oy, Espoo (FI)

(72) Inventors: Wei ZHAO, Qingdao (CN); Bruno LANDAIS, Lannion (FR); Ioannis MOUROULIS, Athens (GR)

(21) Appl. No.: 18/876,927

(22) PCT Filed: Jun. 21, 2022
(86) PCT No.: PCT/CN2022/100219

§ 371 Date: Dec. 19, 2024

(51) Int. Cl. H04L 67/51; H04L 69/22

(52) U.S. Cl. CPC H04L 67/51; H04L 69/22

(57) ABSTRACT

Embodiments of the present disclosure relate to supporting API prefix in callback URI. A first first device is provided comprising at least one processor and at least one memory storing instructions. The at least one memory and the instructions are configured to, with the at least one processor, cause the first device at least to: receive, from a second device, a service request message, wherein the service request message comprises a first callback Uniform Resource Identifier, URI, with a first Application Programming Interface, API, prefix; in response to determining that the second device is not reachable, send, to a third device, a discovery request for discovering a further second device instance; receive, from the third device, a discovery response; determine a second callback URI based on the discovery response; and send to the further second device instance a callback request message based on the second callback URI.

### TECHNICAL FIELD

Embodiments of the present disclosure generally relate to the field of communication, and in particular, to devices, methods, apparatuses and computer readable storage media for supporting Application Programming Interface (API) prefix in a callback Uniform Resource Identifier (URI).

### BACKGROUND

In Service Based Architecture (SBA) of the 3^{rd} Generation Partnership Project (3GPP), callback URIs (e.g. notification URIs) are URIs used by a Network Function (NF) service producer (NFp) to send a callback request (e.g. a notification request) to an NF service consumer (NFc). The callback URI structure is worth studying and needs to be developed.

### SUMMARY

In general, example embodiments of the present disclosure provide devices, methods, apparatuses and computer readable storage media for supporting API prefix in callback URI.

In a first aspect, there is provided a first device. The first device comprises at least one processor, and at least one memory storing instructions. The at least one memory and the instructions are configured to, with the at least one processor, cause the first device at least to: receive, from a second device, a service request message, wherein the service request message comprises a first callback Uniform Resource Identifier (URI) with a first Application Programming Interface (API) prefix; in response to determining that the second device is not reachable, send, to a third device, a discovery request for discovering a further second device instance; receive, from the third device, a discovery response; determine a second callback URI based on the discovery response; and send to the further second device instance a callback request message based on the second callback URI.

In a second aspect, there is provided a second device. The second device comprises at least one processor, and at least one memory storing instructions. The at least one memory and the instructions are configured to, with the at least one processor, cause the second device at least to: send, to a first device, a service request message, wherein the service request message comprises a first callback Uniform Resource Identifier (URI) with a first Application Programming Interface (API) prefix.

In a third aspect, there is provided a third device. The third device comprises at least one processor, and at least one memory storing instructions. The at least one memory and the instructions are configured to, with the at least one processor, cause the third device at least to: receive, from a second device, a request to register the second device's profile including a default notification subscription, the default notification subscription comprising a first callback Uniform Resource Identifier, URI, with a first Application Programming Interface, API, prefix; receive, from a first device, a first discovery request for discovering the second device; and send, to the first device, a first discovery response including the default notification subscription comprising the first URI with first API prefix.

In a fourth aspect, there is provided a fourth device. The fourth device comprises at least one processor, and at least one memory storing instructions. The at least one memory and the instructions are configured to, with the at least one processor, cause the fourth device at least to: receive, from a second device, a service request message, wherein the service request message comprises a first callback Uniform Resource Identifier (URI) with a first Application Programming Interface (API) prefix; send, to a first device, the service request message; receive, from the first device, a callback request message corresponding to the service request message; in response to determining that the second device is not reachable, send, to a third device, a discovery request for discovering a further second device instance; receive, from the third device, a discovery response; determine a second callback URI based on the discovery response; and send to the further second device instance the callback request message based on the second callback URI.

In a fifth aspect, there is provided a method. The method comprises receiving, from a second device, a service request message. The service request message comprises a first callback Uniform Resource Identifier (URI) with a first Application Programming Interface (API) prefix. The method further comprises in response to determining that the second device is not reachable, sending, to a third device, a discovery request for discovering a further second device instance. The method further comprises receiving, from the third device, a discovery response, determining a second callback URI based on the discovery response, and sending to the further second device instance a callback request message based on the second callback URI.

In a sixth aspect, there is provided a method. The method comprises sending, to a first device, a service request message. The service request message comprises a first callback Uniform Resource Identifier (URI) with a first Application Programming Interface (API) prefix.

In a seventh aspect, there is provided a method. The method comprises receiving, from a second device, a request to register the second device's profile including a default notification subscription, the default notification subscription comprising a first callback Uniform Resource Identifier, URI, with a first Application Programming Interface, API, prefix; receiving, from a first device, a first discovery request for discovering the second device; and sending, to the first device, a first discovery response including the default notification subscription comprising the first URI with the first API prefix.

In an eighth aspect, there is provided a method. The method comprises receiving, from a second device, a service request message. The service request message comprises a first callback Uniform Resource Identifier (URI) with a first Application Programming Interface (API) prefix. The method further comprises sending, to a first device, the service request message, and receiving, from the first device, a callback request message corresponding to the service request message. The method further comprises in response to determining that the second device is not reachable, sending, to a third device, a discovery request for discovering a further second device instance. The method further comprises receiving, from the third device, a discovery response, determining a second callback URI based on the discovery response, and sending to the further second device instance the callback request message based on the second callback URI.

In a ninth aspect, there is provided an apparatus. The apparatus comprises means for performing the method according to the fifth aspect.

In a tenth aspect, there is provided an apparatus. The apparatus comprises means for performing the method according to the sixth aspect.

In an eleventh aspect, there is provided an apparatus. The apparatus comprises means for performing the method according to the seventh aspect.

In a twelfth aspect, there is provided an apparatus. The apparatus comprises means for performing the method according to the eighth aspect.

In a thirteenth aspect, there is provided a computer readable medium having instructions stored thereon. The instructions, when executed on at least one processor of a device, cause the device to perform the method according to the fifth, sixth, seventh, and eighth aspects.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example communication system in which implementations of the present disclosure can be implemented;

FIG. 2 illustrates an example signaling chart showing an example process for supporting API prefix in callback URI between a NF service producer, a NF service consumer and a Network Repository Function (NRF), in accordance with some embodiments of the present disclosure;

FIG. 3 illustrates an example signaling chart showing an example process for supporting API prefix in callback URI between a NF service producer, a NF service consumer and a NRF and a Service Communication Proxy (SCP), in accordance with some embodiments of the present disclosure;

FIG. 4 illustrates a flowchart of an example method in accordance with some embodiments of the present disclosure;

FIG. 5 illustrates a flowchart of another example method in accordance with some embodiments of the present disclosure;

FIG. 6 illustrates a flowchart of another example method in accordance with some embodiments of the present disclosure;

FIG. 7 illustrates a flowchart of another example method in accordance with some embodiments of the present disclosure;

FIG. 8 shows a simplified block diagram of a device that is suitable for implementing example embodiments of the present disclosure; and

FIG. 9 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communication between a terminal device and a network device in the communication network may be performed according to any suitable generation communication protocols, including, but not limited to, the fourth generation (4G), 4.5G, the future fifth generation (5G) new radio (NR) communication protocols, and/or any other protocols either currently known or to be developed in the future. Embodiments of the present disclosure may be applied in various communication systems. Given the rapid development in communication, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

As mentioned above, in the 5G Service Based Architecture (SBA), callback URIs (e.g. notification URIs) are URI used by an NF service producer (NFp) to send a callback request (e.g. a notification request) to an NF service consumer (NFc).

In the latest version of 3GPP TS 29.501, the Callback URI is defined with the following structure:
URI=scheme “:” “//” host [“:” port]/path
   Where ‘path’ is a path to an NF service consumer resource.

Unlike Resource URI and Custom operations URI, the Callback URI structure does not support an optional deployment-specific string, a.k.a., API prefix.

Moreover, in a Change Request (CR) agreed by 3GPP CT4, it is provided the flexibility to an NF service consumer to implement different NF service consumer instances sharing the same authority information. In the agreed CR, NF service consumer instances sharing the same authority can be distinguished from each other by using a unique prefix information per NF service consumer instance. The 3gpp-Sbi-Consumer-Info instance was extended with a new “callback-uri-prefix.”

It is usually not a problem that the Callback URI structure above does not have the deployment-specific API prefix explicitly listed. If desired, the NF service consumer (e.g., NF-1) can still deploy the Notification Endpoint with a specific prefix, and thus notification URI can implicitly include this deployment-specific API prefix (e.g., api-prefix-1) as the leading part of the ‘path’ field.

However, the situation would become different, when the above NF-1 notification endpoint with api-prefix-1 is not reachable. The NF service producer or the SCP may reselect a different NF service consumer instance, using the binding information received together with the callback URI from the NF service consumer (e.g. when a subscription to notification is performed) or, when binding procedures are not supported, leveraging the information that the NF service consumer is part of an NF (service) set or supports context sharing across its NF service instances.

When this occurs, using the Binding Indication if available or the NF service consumer's NF profile in a NRF, the notification sender (which is also the NF service producer serving the subscription) or a SCP, does an NF Discovery request towards the NRF to reselect the endpoint address of another NF or another NF service instance (e.g., NF-2), to construct a new Notification Endpoint to send the notification. Specifically, the notification sender or SCP may exchange the authority part of the notification URI (or Callback URI) with the new notification endpoint address and shall use that URI in subsequent notifications.

If the NF-1 deploys the notification endpoint with api-prefix-1, and after the above reselection procedure is applied, the api-prefix-1 of the NF-1 would be carried over and sent to the new Notification Endpoint to the NF-2.

This may be problematic. Since the api-prefix-1 is deployment-specific, it is possible that there is some information specific to, and maybe, only applicable to the NF-1, is included in the api-prefix-1. This may include, but is not limited to customized software version, HTTP2 route selector, etc. The api-prefix-1 is to be sent to the NF-2. But the NF-2 may not have the same customized software version with the NF-1, or it is possible that, the NF-2 may even not share the same HTTP2 route selector with the NF-1, as it is quite reasonable for a backup NF (the NF-2 can be considered the backup of the NF-1) to be located in a different cluster, region, or location, so the HTTP2 route selector to reach NF-2 can be different.

As a result, the new Notification Endpoint to the NF-2, would either not able to be routed to the NF-2 due to unmatched route selector, or, may not be recognized or correctly processed by the NF-2 due to customized software version difference.

Moreover, When the SCP is responsible for reselecting the target NF service consumer, the SCP cannot determine whether the callback URI includes a prefix or not, and accordingly, whether it should also replace the prefix part of the callback URI with the prefix of the reselected target NF service instance.

Currently, to get rid of the above-mentioned problem, some methods may be adopted. One method may be that do not include API prefix in the notification URI (or Callback URI) at all. This means there is no deployment-specific flexibility when deploying the notification endpoint. So some critical information, e.g., customized software version, HTTP2 route selector, has no way to be conveyed in the notification URI (or Callback URI), which is inconsistent with the Resource URI, and is also causing problems in actual business due to the absence of the critical information.

Another method may be that always use the same API prefix in all notification URIs (or Callback URIs) generated from NFs with binding relation. This means, any specific information conveyed in API prefix, like customized software version, HTTP2 route selector, should always be the same in these NFs. This seems quite straightforward but could potentially cause severe problem. If the API prefix is the same, it means the critical deployment specific information convened in API prefix is also the same on both sides. For example, both NFs are running the same the customized software version. If one NF is not reachable due to some software defect, most likely, the other NF would have the same defect and could also be unreachable. It also means both NFs should probably be upgraded together, due to the needs of keeping same customized software version, and canary style or phased upgrade is not possible among the NFs with binding relation, etc.

Another method introduces the option of having a prefix in the callback URI, but the solution has several flaws, e.g., the SCP cannot know when receiving a callback request whether the callback prefix includes a prefix or not (since the 3gpp-Sbi-Consumer-Info header is not signaled in callback/notification requests), and accordingly, whether the SCP should also modify the prefix when reselecting a different NF service consumer instance. Furthermore, the support of prefix in the callback URI is unnecessarily restricted to use cases of the NF service consumer instances sharing the same authority. The NF service consumer reselection procedures by the SCP do not work.

Embodiments of the present disclosure propose a method for supporting the API prefix in the callback URI. The proposed solution enhances the structure of notification URI (or Callback URI) to show the optional presence of API prefix explicitly.

The proposed solution also enhances 3gpp-Sbi-Binding header and 3gpp-Sbi-Routing-Binding header, to have them convey a new parameter to indicate the presence and value of API prefix in the notification URI (or Callback URI), if the notification URI (or Callback URI) indeed has an API prefix.

The proposed solution also enables to explicitly signal the presence and value of API prefix in the callback URI, when binding procedures are not supported, to enable the SCP to know that the callback URI contains a prefix part. The explicit indication about the prefix part that is present within the callback URI may be indicated in an HTTP header, e.g. in or extension of the 3gpp-Sbi-Request-Info header in a new 3gpp-Sbi-callback-uri-prefix header or in a new 3gpp-Sbi-callback-uri-apiRoot header (and accordingly in a new prefix or apiRoot IE in DefaultNotificationSubscriptions).

Further, the proposed solution also enhances the NF service consumer reselection procedure, to not only exchange the authority part of the notification URI (or Callback URI), but also exchange the API prefix, i.e., replace the API prefix (if present) with the API prefix (if present) returned from the reselection NF Discovery procedure, to form the new notification URI (or Callback URI), whereby the reselection may be performed by the NF service producer or the SCP.

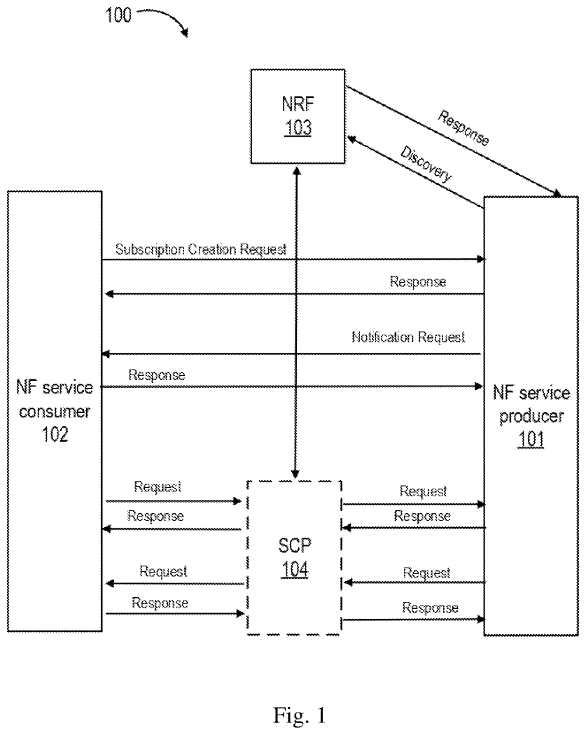

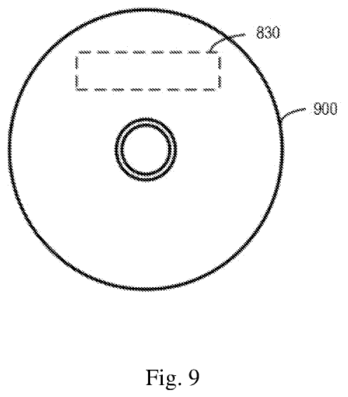

Principle and implementations of the present disclosure will be described in detail below with reference to FIGS. 1 to 9.

FIG. 1 shows an example communication system 100 in which embodiments of the present disclosure can be implemented. The system 100 includes a NF service producer 101, a NF service consumer 102, a NRF 103 and optionally a SCP 104.

In some embodiments, the NF service consumer 102 may send a service request (e.g., a subscription creation request) to the NF service producer 101, and the NF service producer 101 may send a service response to the NF service consumer 102 telling whether the request was handled successfully at the NF service producer 101. Furthermore, the NF service producer 101 may send a notification request to the NF service consumer 102, to which the NF service consumer 102 may responds by a notification response telling whether the notification was handled successfully at the NF service consumer 102. In some embodiments, the NF service producer 101 may also send a discovery request to the NRF 103, and in response to receiving the discovery request, the NRF 103 may send a discovery response to the NF service producer 101.

In some embodiments, for example, in the indirect communication, a SCP 103 is provided. In this case, the NF service consumer 102 may send a service request (e.g., a subscription creation request) to the SCP 103, and the SCP 103 forwards the service request to the NF service producer 101. In response to the service request, the NF service producer 101 may send a service response telling whether the request was handled successfully at the NF service producer 101 to the SCP 103, and the SCP 103 may forward the service response to the NF service consumer 102. Furthermore, the NF service producer 101 may send a notification request to the SCP 103, and the SCP 103 may forward the notification request the NF service consumer 102. In response to the notification request, the NF service consumer 102 may send a notification response telling whether the notification was handled successfully at the NF service consumer 102 to the SCP 103, and the SCP 103 may forward the notification response to the NF service consumer 102. In some embodiments, the SCP 103 may also communicate with the NRF 103, e.g., perform a discovery procedure.

Communications in the communication system 100 may be implemented according to any generation communication protocols either currently known or to be developed in the future. Examples of the communication protocols include, but not limited to, the fourth generation (4G), 4.5G, the fifth generation (5G) communication protocols, 5.5G, 5G-Advanced networks, or the sixth generation (6G) networks.

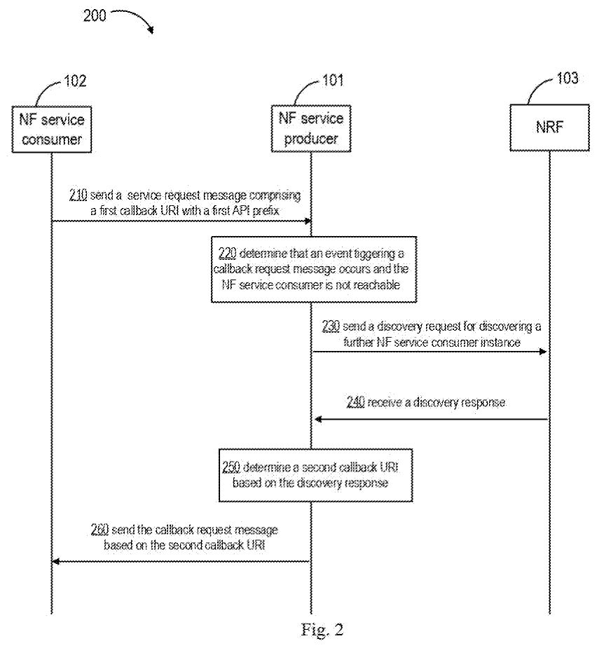

FIG. 2 illustrates an example signaling chart showing an example process 200 for supporting API prefix in callback URI according to some example embodiments of the present disclosure. For the purpose of discussion, the process 200 will be described with reference to FIG. 1. The process 200 may involve the NF service producer 101, the NF service consumer 102 and the NRF 103 as illustrated in FIG. 1. Although the process 200 has been described in the communication system 100 of FIG. 1, this process may be likewise applied to other communication scenarios.

As shown in FIG. 2, the NF service consumer 102 sends 210 to the NF service producer 101 a service request message (e.g., a subscription creation request message). The service request message comprises a first URI (e.g., callback URI) with a first API prefix, which is the URI at which the NF service consumer expects to receive subsequent notification (i.e. callback) requests from the NF service producer. In some embodiments, the first callback URI may have the following structure:
URI={apiRoot}/path

In which, the apiRoot is a concatenation of the following parts:
scheme (i.e., “http” or “https”)
the fixed string “://”
authority (host and optional port), the host should be represented by the operator specific Fully Qualified Domain Name (FQDN)
an optional deployment-specific string (i.e., API prefix) that starts with a “/” character.

That is, the URI has an optional API prefix. With this enhancement, any notification URI (or callback URI) sent as part of the subscription creation request message, would have the flexibility to include the API prefix.

Furthermore, a 3gpp-Sbi-Binding header (e.g. present in the subscription creation request) may include a new optional parameter to indicate the presence and the actual value of the API prefix in the URI structure defined above.

There are two options to indicate the presence and the value of the API prefix. For example, in some embodiments, directly present the value of the API prefix in the new parameter. Alternatively, in the new parameter, list the rest part of the ‘path’ from the URI with leading API prefix stripped (or list the apiRoot only).

An example of the 3gpp-Sbi-Binding header for the case that directly present the value of the API prefix in the new parameter is provided as follows:

3gpp-Sbi-Binding = “3gpp-Sbi-Binding” “:” 1#(OWS “bl=” blvalue 1*(“;” OWS
parameter) [“;” OWS recoverytime] [“;” OWS notif-receiver] [“;” OWS
callback-uri-prefix] [“;” OWS “group=” groupvalue] [1*(“;” OWS groupparameter)])
callback-uri-prefix = “callback-uri-prefix=” deployment-specific string

An example of the 3gpp-Sbi-Binding header for the case that list the rest part of the ‘path’ from the URI with leading API prefix stripped is provided as follows:

3gpp-Sbi-Binding = “3gpp-Sbi-Binding” “:” 1#(OWS “bl=” blvalue 1*(“;” OWS
parameter) [“;” OWS recoverytime] [“;” OWS notif-receiver] [“;” OWS
uri-path-without-prefix] [“;” OWS “group=” groupvalue] [1*(“;” OWS
groupparameter)])
uri-path-without-prefix = “uripath=” path part of the URI with API prefix stripped

The name of the new parameter is provided for purpose of illustration without suggesting any limitations. It is noted that any other naming convention of the new parameter different from the examples given below are also within the scope of the present disclosure.

With this enhancement, the Binding Indication that may be sent as part of the subscription request may indicate the presence and the actual value of the API prefix in the notification URI (or callback URI).

It is noted that this covers both “subscription-events” and “callback” cases as specified by the “scope” parameter in the 3gpp-Sbi-Binding header defined in 3GPP TS 29.500. This approach solves the issues in a simple way, when binding procedures are supported.

As shown in FIG. 2, when later on an event to which the NF service consumer has subscribed occurs, the NF service producer 101 determines 220 that the NF service consumer 102 is not reachable and in response to the determination, the NF service producer 101 performs a NF service consumer reselection procedure. For example, the NF service producer 101 sends 230 to the NRF 103 a discovery request to discover an alternative NF service consumer instance for sending the notification request, and receives 240 from the NRF 103 a discovery response.

In some embodiments, the NF service consumer reselection procedure may be enhanced by requiring to not only exchange the Endpoint Address, i.e., the authority part of the notification URI (or callback URI), but also exchange the API prefix, i.e., replace the API prefix (if present) with the API prefix (if present) returned from the reselection NF discovery procedure, to form the new notification URI (or callback URI).

The service name that may be present in the callback URI or in the Binding Indication is used to discover an alternative NF service consumer instance.

As shown in FIG. 2, the NF service producer 101 determines 250 a second callback URI based on the discovery response.

Here an example is given below. Only the new parameter from the present disclosure is shown in the 3gpp-Sbi-Binding header and the rest other parameters are shown as “ . . . ”. The name of the new parameter is provided for purpose of illustration without suggesting any limitations. It is noted that any other naming convention of the new parameter different from this example, as well as the different combinations of the existing parameters in 3gpp-Sbi-Binding header that may or may not come together with the new parameter in 3gpp-Sbi-Binding header, are all within the scope of the present disclosure.

The first URI (notification URI or callback URI) sent in the subscription creation request may be as follows:
http://a.example.com/api-prefix-1/path-to-notification-target

Binding Indication sent in the subscription message may be as follows:
3gpp-Sbi-Binding: . . . ; callback-uri-prefix=/api-prefix-1; . . .

New endpoint address, e.g., FQDN, as a result of the NF discovery using information provided in Binding Indication may be as follows:
b.example.com

API prefix from the result of the NF discovery using information provided in Binding Indication may be as follows:
/api-prefix-2

With this disclosure applied, the new notification URI (or callback URI), i.e., the second callback URI, to send the notification to, may become:
http://b.example.com/api-prefix-2/path-to-notification-target

It is possible that, after the NF discovery, there is no new API prefix, e.g., there is no service name given in Binding Indication, or, there is no API prefix in the NF service discovered, etc. In this case, it is safe to just remove the old API prefix (i.e., the first API prefix), without adding any new API prefix; the new notification URI (or callback URI), i.e., the second callback URI, to send the notification to, may become this in the context of this example, i.e., old API prefix gets removed, with only Endpoint Address changed:
http://b.example.com/path-to-notification-target

There are many advantages of the present disclosure. For example, each Notification Endpoint can have independent API prefix for deployment specific purpose, this enables the possible independent customized software versions, independent HTTP2 route rules, independent upgrade phases, etc., among the NFs with binding relation for notification. So, the overall reliability and robustness of the system is increased.

Different NF service consumer instances may share the same authority but different prefixes. The NF service producer can now reselect an alternative NF service consumer instance and replace the authority and prefix in the callback URI with the authority and callback URI of the new NF service consumer service instance, e.g.,
https://amf45.operator.com/servinst123/pdusession/v1/
   by
https://amf45.operator.com/servinst65/pdusession/v1/
   where “pdusession” corresponds to the NF service consumer service (that may be a custom service like in the example or a standard service name).

As shown in FIG. 2, the NF service producer 101 sends 260 to the alternative NF service consumer instance a callback request message (e.g., notification request message) based on the second callback URI. The alternative NF service consumer instance may be a reachable address of the NF service consumer 102 or a NFc different from the NF service consumer 102.

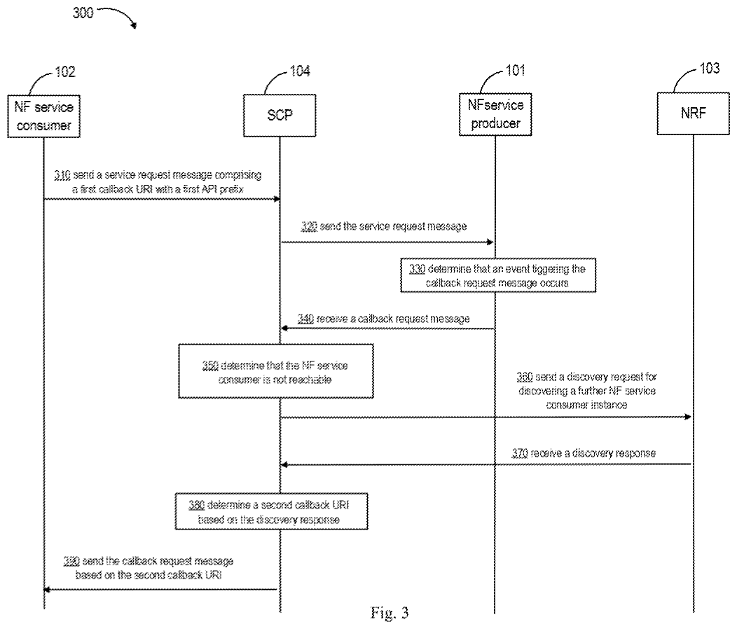

FIG. 3 illustrates an example signaling chart showing an example process 300 for supporting API prefix in callback URI according to some example embodiments of the present disclosure. For the purpose of discussion, the process 300 will be described with reference to FIG. 1. The process 300 may involve the NF service producer 101, the NF service consumer 102, the NRF 103 and the SCP 104 as illustrated in FIG. 1. Although the process 300 has been described in the communication system 100 of FIG. 1, this process may be likewise applied to other communication scenarios.

As shown in FIG. 3, the NF service consumer 102 sends 310 to the SCP 104 a service request message (e.g., a subscription creation request message). The service request message comprises a first URI (e.g., callback URI) with a first API prefix, and the first callback URI may have the same structure as that described above by referring to FIG. 2. The SCP 104 sends 320 the service request message to the NF service producer 101.

If the NF service producer 101 determines 330 that an event occurs that triggers a callback request message to be sent to the NF service consumer 102, the NF service producer 101 sends the callback request message to the SCP 104, i.e., the SCP 104 receives 340 from the NF service producer 101 the callback request message. Then, if the SCP 104 determines 350 the NF service consumer 102 is not reachable, the SCP 104 performs a NF service consumer reselection procedure. For example, the SCP 104 sends 360 to the NRF 103 to reselect an alternative NF service consumer instance for the related service request message, and receives 370 from the NRF 103 a discovery response.

In addition to the 3gpp-Sbi-Binding header enhancement described above by referring to FIG. 2, the 3gpp-Sbi-Routing-Binding header may be also enhanced to optionally carry a new parameter to indicate the presence and the actual value of the API prefix in the callback URI (or notification URI).

Similar to the 3gpp-Sbi-Binding header enhancement, there are also two options to indicate the presence and the actual value of the API prefix in the callback URI (or notification URI). For example, in some embodiments, directly present the value of the API prefix in the new parameter. Alternatively, in the new parameter, list the rest part of the ‘path’ from the URI with leading API prefix stripped (or list the apiRoot only).

In some embodiments, it enables to explicitly signal the presence and value of the API prefix in the callback URI, when binding procedures are not supported, to enable the SCP 104 to know that the callback URI contains a prefix part. The explicit indication about the prefix part that is present within the callback URI may be indicated in an HTTP header, e.g. in extension of the 3gpp-Sbi-Request-Info header or in a new 3gpp-Sbi-callback-uri-prefix header.

For example, a new 3gpp-Sbi-callback-uri-prefix header is defined as a 3GPP HTTP custom header as follows:

```
  3gpp-Sbi-callback-uri-prefix header field =
“3gpp-Sbi-callback-uri-prefix” “:” OWS prefix
  prefix = path-absolute
  An example is: 3gpp-Sbi-callback-uri-prefix: /a/b/c
```

Alternatively, a new 3gpp-Sbi-callback-apiRoot header may be defined as follows:

3gpp-Sbi-callback-apiRoot header field = “3gpp-Sbi-callback-apiRoot” “:”
OWS
scheme “://” authority [ prefix ]
scheme = “http” / “https”
authority = host [ “:” port ]
port = *DIGIT
prefix = path-absolute
An example is: 3gpp-Sbi-callback-apiRoot: https://example.com/a/b/c

When binding procedures are not supported, the name of the NF service consumer's service may need to be explicitly indicated in the callback URI as follows:
URI={apiRoot}/<service name>/path

This is to allow the NF service producer 101 or the SCP 104 to reselect an alternative NF service consumer instance from the same service. Note that when binding procedures are supported, the service name of the NF service consumer can already be signalled by a distinct parameter in the binding indication.

Accordingly, when binding procedures are not supported, the API Prefix can be identified in the NF service consumer's profile registered at the NRF, for explicit subscriptions (i.e. subscriptions created by the NF service consumer by a subscription creation request); for default notification subscriptions (i.e. implicit subscriptions registered by the NF service consumer in its NF profile in the NRF) the API prefix can be identified by a newly introduced IE within DefaultNotificationSubscriptions as defined in Table 1 below:

TABLE 1

| Attribute | | | | |
|---|---|---|---|---|
| name | Data type | P | Cardinality | Description |
| notificationType | NotificationType | M | 1 | Type of notification for which the |
| | | | | corresponding callback URI is provided. |
| callbackUri | Uri | M | 1 | This attribute contains a default notification |
| | | | | endpoint to be used by a NF Service Producer |
| | | | | towards an NF Service Consumer that has not |
| | | | | registered explicitly a callback URI in the NF |
| | | | | Service Producer (e.g. as a result of an implicit |
| | | | | subscription). |
| . . . | | | | |
| uriPrefix | string | O | 1 | Optional path segment(s) used to construct the |
| | | | | {apiRoot} variable of the different Callback |
| | | | | API URIs, as described in 3GPP TS 29.501 [5], |
| | | | | clause 4.4.1 (optional deployment-specific |
| | | | | string that starts with a “/” character). |

In addition, when the SCP 104 reselects a consumer service instance, it shall add the 3gpp-target-apiRoot Header in the notification Response sent towards the NF service producer 101 which apart of the new authority shall also newly include the new API prefix (if any) of the new callback URI.

As shown in FIG. 3, the SCP 104 determines 380 a second callback URI based on the discovery response. The determination of the second callback URI has been described above by referring to FIG. 2.

Then, the SCP 104 sends 390 the callback request message based on the second callback URI.

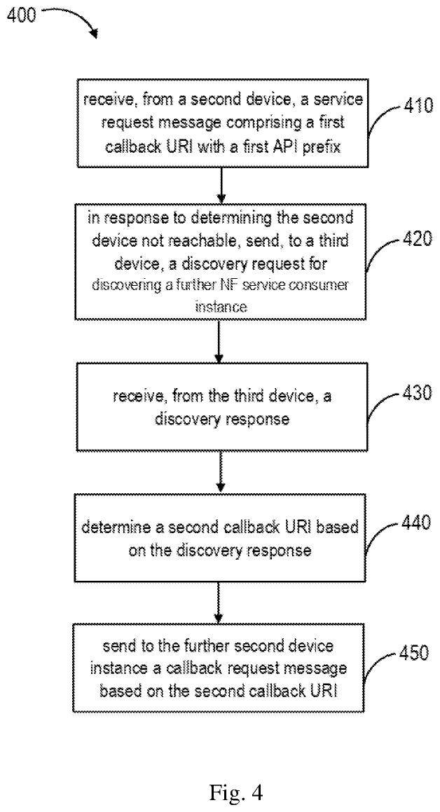

FIG. 4 illustrates a flowchart of an example method 400 in accordance with some embodiments of the present disclosure. The method 400 can be implemented at the NF service producer 101 or the SCP 104 as shown in FIG. 1. For the purpose of discussion, the method 400 will be described with reference to FIGS. 1-3.

At block 410, the first device (e.g., the NF service producer 101 or the SCP 104) receives, from a second device (e.g., the NF service consumer 102), a service request message. The service request message comprises a first callback URI with a first API prefix.

In some embodiments, the first callback URI may comprise an apiRoot part and a path part. The apiRoot part may comprise at least the first API prefix and a first authority part.

In some embodiments, the service request message may further comprise binding information. The binding information may also be received and indicate a value of the first API prefix in a first parameter. In some embodiments, binding information may list the first API prefix of the first callback URI in the first parameter. Alternatively or in addition, the binding information may list the apiRoot part of the first callback URI in the first parameter. Alternatively or in addition, the binding information may list a remaining part of the first callback URI with the apiRoot part stripped in the first parameter.

At block 420, in response to determining that the second device is not reachable, the first device sends to a third device (e.g., the NRF 103) a discovery request for discovering a further second device instance towards which to send notifications for the related subscription.

At block 440, the first device receives, from the third device, a discovery response.

At block 450, the first device determines a second callback URI based on the discovery response.

In some embodiments, the first device may strip the first API prefix from the first callback URI based on the first parameter of the binding information, and fill the first callback URI with a second API prefix indicated in the discovery response to form the second callback URI if the second API prefix is indicated in the discovery response. Alternatively or in addition, the first device may strip the first authority part from the first callback URI based on the first parameter of the binding information, and fill the first callback URI with a second authority part indicated in the discovery response to form the second callback URI.

In some embodiments, if the second device does not support binding procedure (e.g., the service request message does not comprise binding information), the service request message may indicate a value of the first API prefix in a second parameter. The second parameter may comprise an HTTP header or a new header. In some embodiments, the service request message may list the first API prefix of the first callback URI in the second parameter. Alternatively or in addition, the service request message may list the apiRoot part of the first callback URI in the second parameter. Alternatively or in addition, the service request message may list a remaining part of the first callback URI with the apiRoot part stripped in the second parameter.

In some embodiments, the first device may strip the first API prefix from the first callback URI based on the second parameter of the callback request message, and fill the first callback URI with a second API prefix indicated in the discovery response to form the second callback URI if the second API prefix is indicated in the discovery response. Alternatively or in addition, the first device may strip the first authority part from the first callback URI based on the second parameter of the binding information, and fill the first callback URI with a second authority part indicated in the discovery response to form the second callback URI.

At block 460, the first device sends to the further second device instance a callback request message based on the second callback URI.

In some embodiments, the service request message may be a subscription creation request message and the callback request message may be a notification request message.

In some embodiments, the further second device instance may be a NF service consumer different from the second device or the further second device instance may be a reachable address of the second device.

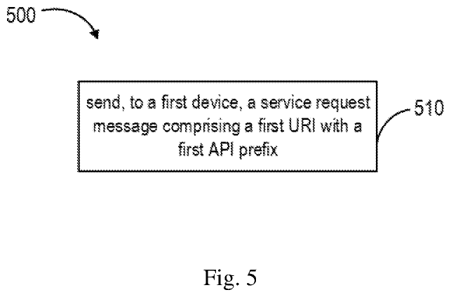

FIG. 5 illustrates a flowchart of an example method 500 in accordance with some embodiments of the present disclosure. The method 500 can be implemented at the NF service consumer 102 as shown in FIG. 1. For the purpose of discussion, the method 500 will be described with reference to FIGS. 1-3.

At block 510, the second device (e.g., the NF service consumer 102) sends to a first device (e.g., the NF service producer 101 or the SCP 104) a service request message. The service request message comprises a first callback URI with a first API prefix.

In some embodiments, the first callback URI may comprise an apiRoot part and a path part. The apiRoot part may comprise at least the first API prefix and a first authority part.

In some embodiments, the service request message may further comprise binding information. The binding information may indicate a value of the first API prefix in a first parameter. In some embodiments, the binding information may list the first API prefix of the first callback URI in the first parameter. Alternatively or in addition, the binding information may list the apiRoot part of the first callback URI in the first parameter. Alternatively or in addition, the binding information may list a remaining part of the first callback URI with the apiRoot part stripped in the first parameter.

In some embodiments, if the second device does not support binding procedure (e.g., the service request message does not comprise binding information), the service request message may indicate a value of the first API prefix in a second parameter. The second parameter may comprise an HTTP header or a new header. In some embodiments, the service request message may list the first API prefix of the first callback URI in the second parameter. Alternatively or in addition, the service request message may list the apiRoot part of the first callback URI in the second parameter. Alternatively or in addition, the service request message may list a remaining part of the first callback URI with the apiRoot part stripped in the second parameter.

In some embodiments, the second device may receive form the first device a callback request message with a second callback URI. The first API prefix of the second callback URI may be stripped based on the first parameter of the binding information. Alternatively, the first API prefix of the second callback URI may be stripped based on the second parameter of the service request message.

In some embodiments, the second callback URI may comprise a second API prefix that replaces the first API prefix. Alternatively or in addition, the second callback URI may comprise a second authority part that replaces the first second authority part.

In some embodiments, the service request message is a subscription creation request message and the callback request message is a notification request.

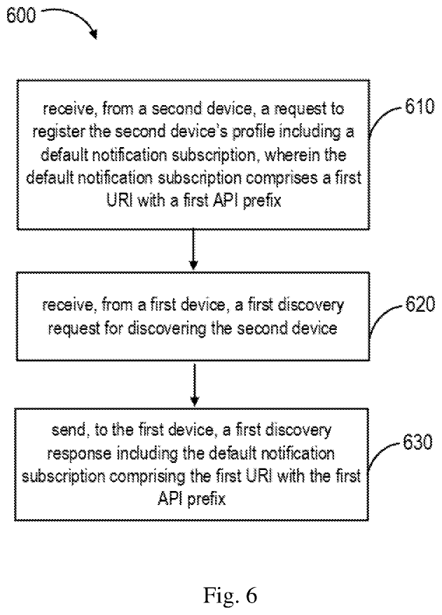

FIG. 6 illustrates a flowchart of an example method 600 in accordance with some embodiments of the present disclosure. The method 600 can be implemented at the NRF 103 as shown in FIG. 1. For the purpose of discussion, the method 600 will be described with reference to FIGS. 1-3.

At block 610, the third device (e.g., the NRF 103) receives from a second device (e.g., the NF service consumer 102), a request to register the second device's profile including a default notification subscription. The default notification subscription comprises a first URI with a first API prefix.

At block 620, the third device receives from a first device (e.g., the NF service producer 101 or the SCP 104) a first discovery request for discovering the second device. Then, at block 630, the third device sends to the first device a first discovery response including the default notification subscription comprising the first URI with the first API prefix.

If the first device determines that the second device is not reachable via the first URI, upon for example an occurrence of an event that triggers the first device to send a callback request message to the second device, the first device may perform a rediscovery procedure. In this case, the third device may receive from the first device a second discovery request for discovering a further second device instance.

In some embodiments, the third device may determine the contents of the second discovery response based on the default notification subscription and the second discovery request.

In some embodiments, the third device may send to the first device the second discovery response including a second callback URI with a second API prefix of the further second device instance.

In some embodiments, the further second device instance may be a NF service consumer different from the second device or the further second device instance may be a reachable address of the second device.

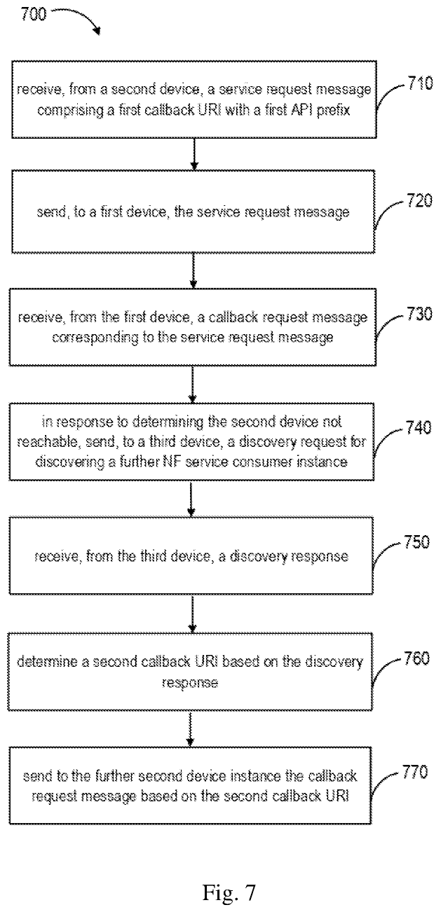

FIG. 7 illustrates a flowchart of an example method 700 in accordance with some embodiments of the present disclosure. The method 700 can be implemented at the SCP 104 as shown in FIG. 1. For the purpose of discussion, the method 700 will be described with reference to FIGS. 1-3.

At block 710, the fourth device (e.g., the SCP 104) receives from a second device (e.g., the NF service consumer 102) a service request message. The service request message comprises a first callback URI with a first API prefix.

In some embodiments, the first callback URI may comprise an apiRoot part and a path part. The apiRoot part may comprise at least the first API prefix and a first authority part.

In some embodiments, the service request message may further comprise binding information. The binding information may indicate a value of the first API prefix in a first parameter. In some embodiments, the binding information may list the first API prefix of the first callback URI in the first parameter. Alternatively or in addition, the binding information may list the apiRoot part of the first callback URI in the first parameter. Alternatively or in addition, the binding information may list a remaining part of the first callback URI with the apiRoot part stripped in the first parameter.

At block 720, the fourth device sends to a first device (e.g., the NF service producer 102) the service request message.

At block 730, the fourth device receives from the first device a callbackn request message corresponding to the service request message.

In some embodiments, the callback request message may comprise routing binding information that indicates a value of the first API prefix in a second parameter. In some embodiments, the callback request message may comprise routing binding information that lists the first API prefix of the first callback URI in the second parameter. Alternatively or in addition, the callback request message may comprise routing binding information that lists the apiRoot part of the first callback URI in the second parameter. Alternatively or in addition, the callback request message may comprise routing binding information that lists a remaining part of the first callback URI with the apiRoot part stripped in the second parameter.

In some embodiments, the callback request message may indicate a value of the first API prefix in a third parameter. The third parameter may comprise an HTTP header or a new header. In some embodiments, the callback request message may list the first API prefix of the first callback URI in the second parameter. Alternatively or in addition, the service request message may list the apiRoot part of the first callback URI in the second parameter. Alternatively or in addition, the callback request message may list a remaining part of the first callback URI with the apiRoot part stripped in the second parameter.

At block 740, in response to determining that the second device is not reachable, the fourth device sends to a third device (e.g., the NRF 103) a discovery request for the service request message.

At block 750, the fourth device receives from the third device a discovery response for discovering a further second device instance.

At block 760, the fourth device determines a second callback URI based on the discovery response.

In some embodiments, to determine the second callback URI, the fourth device may strip the first API prefix from the first callback URI based on the second parameter of the binding information, and fill the first callback URI with a second API prefix indicated in the discovery response to form the second callback URI if the second API prefix is indicated in the discovery response. Alternatively or in addition, the fourth device may strip the first authority part from the first callback URI based on the second parameter of the binding information, and fill the first callback URI with a second authority part indicated in the discovery response to form the second callback URI.

In some embodiments, to determine the second callback URI, the fourth device may strip the first API prefix from the first callback URI based on the third parameter of the callback request message, and fill the first callback URI with a second API prefix indicated in the discovery response to form the second callback URI if the second API prefix is indicated in the discovery response. Alternatively or in addition, the fourth device may strip the first authority part from the first callback URI based on the third parameter of the callback request message, and fill the first callback URI with a second authority part indicated in the discovery response to form the second callback URI.

At block 770, the fourth device sends to the further second device instance the callback request message based on the second callback URI.

In some embodiments, the service request message is a subscription creation request message and the callback request message is a notification request message.

In some embodiments, the further second device instance may be a NF service consumer different from the second device or the further second device instance may be a reachable address of the second device.

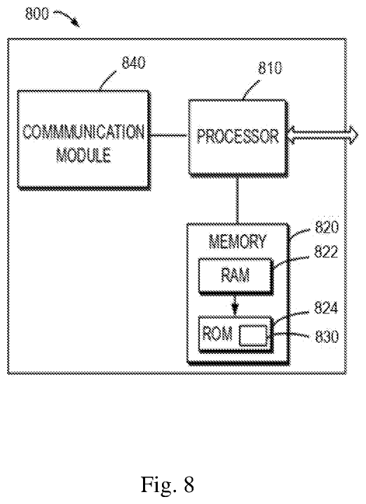

FIG. 8 is a simplified block diagram of a device 800 that is suitable for implementing embodiments of the present disclosure. The device 800 may be provided to implement the communication device, for example the NF service producer 101, the NF service consumer 102, the NRF 103 and the SCP 104 as shown in FIG. 1. As shown, the device 800 includes one or more processors 810, one or more memories 840 coupled to the processor 810, and one or more communication modules (TX/RX) 840 coupled to the processor 810.

The TX/RX 840 is for bidirectional communications. The TX/RX 840 has at least one antenna to facilitate communication. The communication interface may represent any interface that is necessary for communication with other network elements.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The program 830 may be stored in the ROM 820. The processor 810 may perform any suitable actions and processing by loading the program 830 into the RAM 820.

The embodiments of the present disclosure may be implemented by means of the program 830 so that the device 800 may perform any process of the disclosure as discussed with reference to FIGS. 2 to 7. The embodiments of the present disclosure may also be implemented by hardware or by a combination of software and hardware.

In some embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like. FIG. 11 shows an example of the computer readable medium 900 in form of CD or DVD. The computer readable medium has the program 830 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a transitory or non-transitory computer readable storage medium. The computer program product includes computer-executable instructions, such as those included in program modules, being executed in a device on a target real or virtual processor, to carry out the methods 400-700 as described above with reference to FIGS. 4 to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. This program code may be provided to a processor or controller of a general purpose computer, special purpose computer, or other programmable data processing device, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the instructions or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results.

In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

The expression “at least one of A or B” in this document means A, or B, or both A and B.

1-11. (canceled)

12. A network function service consumer comprising:
at least one processor; and
at least one memory storing instructions that, when executed by the at least one processor, cause the network function service consumer at least to:
send, to a network function service producer, a service request, wherein the service request comprises a first callback Uniform Resource Identifier, URI, having a first Application Programming Interface, API, prefix.

13. The network function service consumer of claim 12, wherein the first callback URI comprises an apiRoot part and a path part, and wherein the apiRoot part comprises at least the first API prefix and a first authority part.

14. The network function service consumer of claim 12, wherein the service request further comprises binding information and wherein the binding information includes a first parameter that indicates a value of the first API prefix.

15. The network function service consumer of claim 14, wherein the first parameter included in the binding information lists
the first API prefix of the first callback URI.

16. The network function service consumer of claim 13, wherein the service request a second parameter comprising an HTTP header or a new header, and wherein the second parameter lists at least one of the following:
the first API prefix of the first callback URI,
an apiRoot part of the first callback URI, or
a part of the first callback URI that does not include the apiRoot part of the first callback URI.

17. The network function service consumer of claim 15, wherein the instructions, when executed by the device, further cause the network function service consumer at least to:
receive, from the network function service producer, a callback request having a second callback URI, wherein a first API prefix of the second callback URI does not include the first API prefix of the first callback URI.

18. The network function service consumer of claim 17, wherein the second callback URI comprises at least one of:
a second API prefix; or
a second authority part.

19. The network function service consumer of claim 17 or 18, wherein the service request is a subscription creation request and the callback request is a notification request.

20-48. (canceled)

49. A method, comprising:
sending, by a network function service consumer, to network function service producer, a service request, wherein the service request comprises a first callback Uniform Resource Identifier, URI, having a first Application Programming Interface, API, prefix.

50. The method of claim 49, wherein the first callback URI comprises an apiRoot part and a path part, and wherein the apiRoot part comprises at least the first API prefix and a first authority part.

51. The method of claim 50, wherein the service request further comprises binding information and wherein the binding information includes a first parameter that indicates a value of the first API prefix.

52. The method of claim 51, wherein the first parameter included in the binding information lists
the first API prefix of the first callback URI.

53. The method of claim 51, wherein the service request includes a second parameter comprising an HTTP header or a new header, and wherein the second parameter lists at least one of the following:
the first API prefix of the first callback URI,
an apiRoot part of the first callback URI, or
a part of the first callback URI that does not include the apiRoot part of the first callback URI.

54. The method of claim 51, further comprising:
receiving, by the network function service consumer, a callback request having a second callback URI from the network function service producer, wherein a first API prefix of the second callback URI does not include the first API prefix of the first callback URI.

55. The method of claim 54, wherein the second callback URI comprises at least one of:
a second API prefix; or
a second authority part.

56. The method of claim 54 or 55, wherein the service request message is a subscription creation request and the callback request is a notification request.

57-80. (canceled)

81. A non-transitory computer readable medium comprising instructions for causing an a network function service consumer to perform at least the following:
sending, to a network function service producer, a service request, wherein the service request comprises a first callback Uniform Resource Identifier, URI, having a first Application Programming Interface, API, prefix.

82-83. (canceled)
